(19) United States
(12) Patent Application Publication
(10) Pub. No.: US 2012/0066295 A1
(43) Pub. Date: Mar. 15, 2012

(54) SYSTEM AND METHOD FOR ACCESSING AND UTILIZING A PLURALITY OF SMARTPHONE APPLICATIONS

(76) Inventor: Natarajan Sambamoorthy, Union City, CA (US)

(21) Appl. No.: 13/229,382

(22) Filed: Sep. 9, 2011

Related U.S. Application Data
(60) Provisional application No. 61/381,402, filed on Sep. 9, 2010.

(51) Int. Cl. G06F 15/16

(52) U.S. Cl. 709/203

(57) ABSTRACT

The present invention is a system to access and utilize a plurality of smartphone applications that includes a server system, one or more smartphones and a communications network where the server system is in communication with the smartphones over the communications network. The system smartphone applications include an autograph smartphone application, a memory puzzle smartphone application and a daily journal application, all of which have a plurality of application updates that are provided to the smartphone applications.

This application claims priority to U.S. Provisional Application 61/381,402 filed on Sep. 9, 2010, the entire disclosure of which is incorporated by reference.

### TECHNICAL FIELD & BACKGROUND

The present invention is a system and method for accessing and utilizing a plurality of smartphone applications. More specifically, the present invention generally relates to a unified and standardized device, infrastructure and operating system that can provide an interface to access a plurality of smartphone applications. The concept of mobile virtualization from one device such as a smartphone allows a plurality of customers and vendors to respond to agile market dynamics relatively more efficiently and faster than ever before.

It is an object of the invention to provide a system and method for accessing and utilizing a plurality of smartphone applications that provides a customer with more of a plurality of choices of mobile platforms to choose from while reducing an expenditure on repeated hardware purchases.

It is an object of the invention to provide a system and method for accessing and utilizing a plurality of smartphone applications where a plurality of vendors can reduce manufacturing, shipping and packing costs for multiple hardware devices and can focus on efficiencies in service and relatively better software applications.

It is an object of the invention to provide a system and method for accessing and utilizing a plurality of smartphone applications where multiple current mobile operating systems are run on a single mobile hardware operating system for sharing data and hardware and software resources within the hardware device in real time emulation, where a consumer doesn't have to worry about changing technologies relatively as often to buy new devices for simple usage which also reduces obsolete electronics resulting in less electronics and computer waste and pollution. The system processor can also emulate multiple CPU processors and support a plurality of networking and multimedia features to support the system architecture and method.

It is an object of the invention to provide a system and method for accessing and utilizing a plurality of smartphone applications that result in a reduction in manufacturing hardware devices and packing material further resulting in less carbon emission and reduced disposal of electronic and computer related waste.

What is really needed is a system and method for accessing and utilizing a plurality of smartphone applications that provides a customer with more of a plurality of choices of mobile platforms to choose from while reducing an expenditure on repeated hardware purchases where a plurality of vendors can reduce manufacturing, shipping and packing costs for multiple hardware devices and can focus on efficiencies in service and relatively better software applications where multiple current mobile operating systems are run on a single mobile hardware operating system for sharing data and hardware and software resources within the hardware device in real time emulation, where a consumer doesn't have to worry about changing technologies relatively as often to buy new devices for simple usage which also reduces obsolete electronics resulting in less electronics and computer waste and pollution that result in a reduction in manufacturing hardware devices and packing material further resulting in less carbon emission and reduced disposal of electronic and computer related waste.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a system overview of a system for accessing and utilizing a plurality of smartphone applications, in accordance with one embodiment of the present invention.

FIG. 2A illustrates a block diagram of a server system of a system for accessing and utilizing a plurality of smartphone applications, in accordance with one embodiment of the present invention.

FIG. 2B illustrates a block diagram of an access and utilization app of a system for accessing and utilizing a plurality of smartphone applications, in accordance with one embodiment of the present invention.

FIG. 3 illustrates a front perspective view of an IPhone with an app for a system for accessing and utilizing a plurality of smartphone applications, in accordance with one embodiment of the present invention.

FIG. 4 illustrates a screenshot of an autograph smartphone app, in accordance with one embodiment of the present invention.

FIG. 5 illustrates a screenshot of a home page of a plurality of memory puzzle s of a smartphone app, in accordance with one embodiment of the present invention.

FIG. 6A illustrates a first screenshot of a journal smartphone app, in accordance with one embodiment of the present invention.

FIG. 6B illustrates a second screenshot of a journal smartphone app, in accordance with one embodiment of the present invention.

FIG. 7 illustrates a screenshot of a coupon smartphone app, in accordance with one embodiment of the present invention.

FIG. 8 illustrates a screenshot of a restaurant takeout smartphone app, in accordance with one embodiment of the present invention.

FIG. 9A illustrates a first screenshot of a project management smartphone app, in accordance with one embodiment of the present invention.

FIG. 9B illustrates a second screenshot of a project management smartphone app, in accordance with one embodiment of the present invention.

FIG. 9C illustrates a third screenshot of a project management smartphone app, in accordance with one embodiment of the present invention.

FIG. 10 illustrates a screenshot of a signed doc app, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is utilized repeatedly. The phrase generally does not refer to the same embodiment, however, it may. The terms “comprising”, “having” and “including” are synonymous, unless the context dictates otherwise.

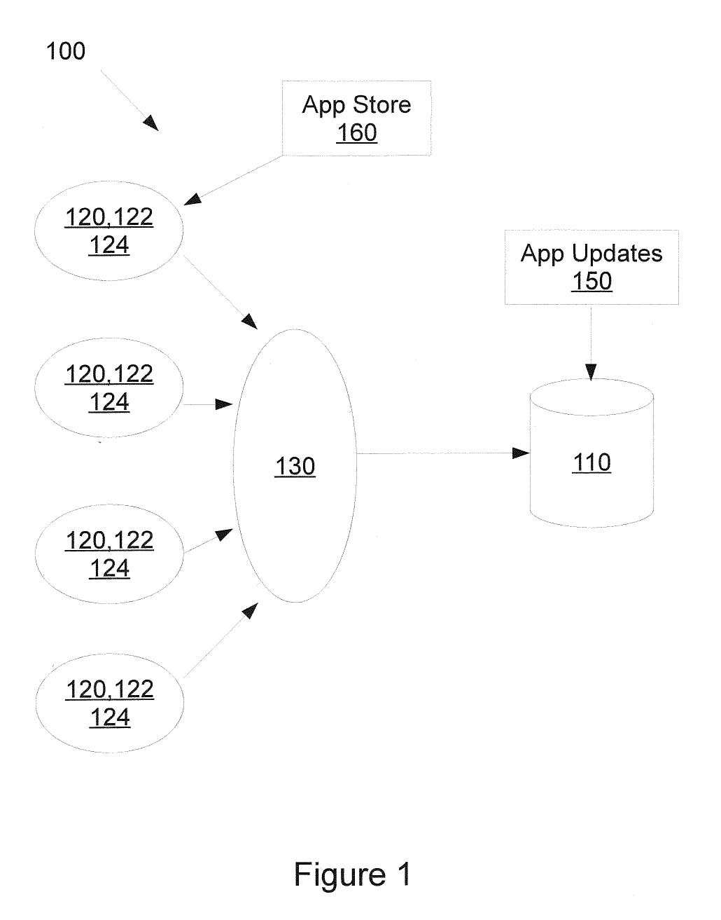

FIG. 1 illustrates a system overview of a computerized system 100 for accessing and utilizing a plurality of smartphone applications, in accordance with one embodiment of the present invention.

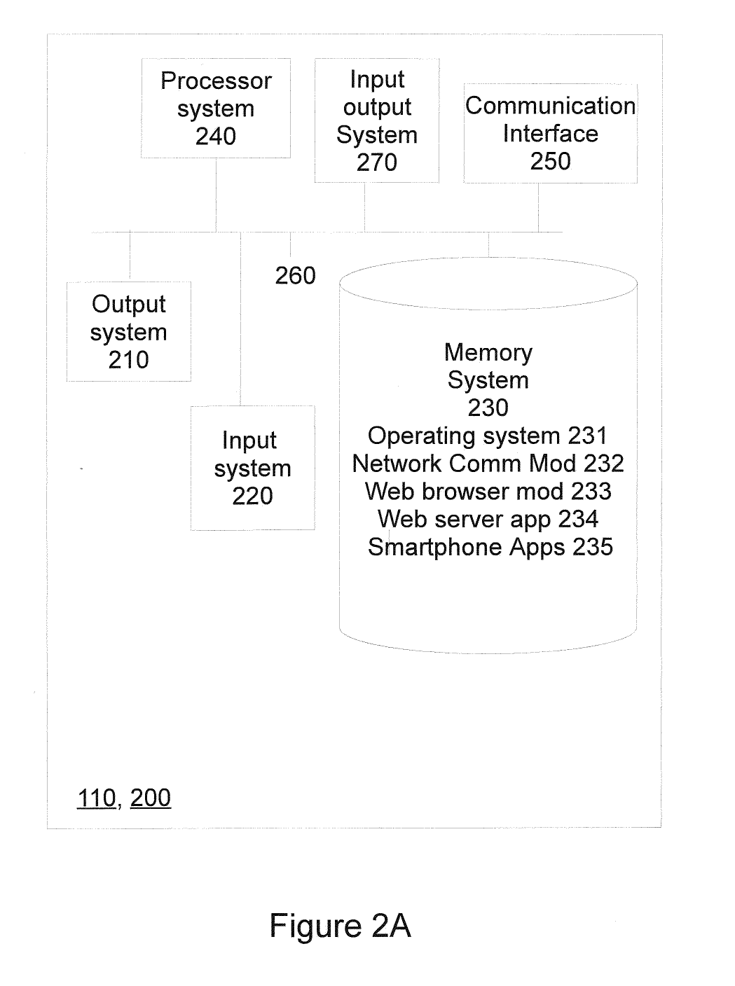

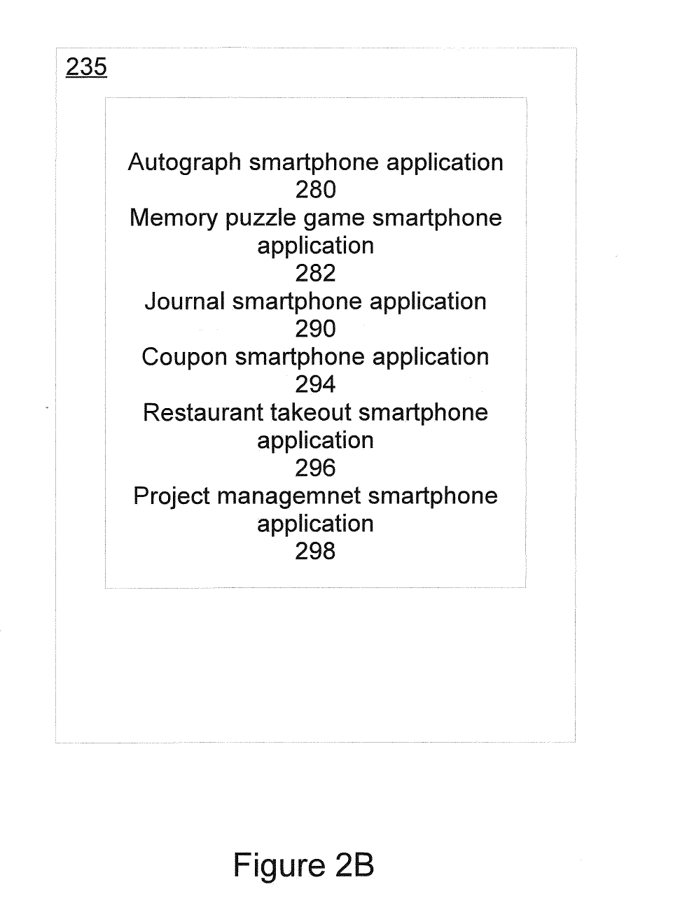

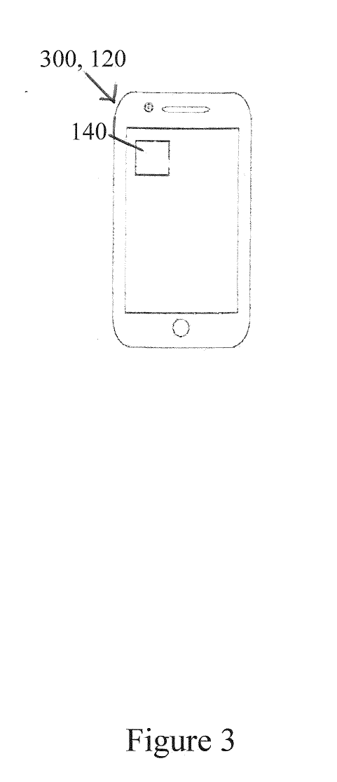

The computerized system 100 includes a server system 110, one or more smartphones 120, a communications network 130, an access and utilization app 140, a plurality of app updates 150 and an app store 160. The server system 110 may have one or more servers and may include additional components and/or may not include all of the components listed above. Further details regarding the server system 110 are described in FIG. 2A. The smartphones 120 are typically an IPHONE™ 122 manufactured by Apple Inc. of Cupertino, Calif. as depicted in FIG. 3 although other suitable smartphones such as a BLACKBERRY™ device manufactured by Research in Motion (RIM) of Waterloo, Ontario, Canada can also be utilized with the computerized system. These smartphones 120 serve as a client system 124 in the computerized system 100. The smartphone 120 supports special software applications operating on various operating systems and can be JAVA enabled or other suitable programming language and computing platform or Binary Runtime Environment for Wireless (BREW) enabled or other suitable application development platform. The communications network 130 may be any one of, or any combination of, one or more Local Area Networks (LANs), Wide Area Networks (WANs), wireless networks, telephone networks, the Internet and/or other suitable networks. The communications network 130 may also include one or more wireless portals. The access and utilization app 140 includes smartphone software that is downloaded from the server system 110 to the smartphone 120. Further details regarding the access and utilization app 140 are provided in FIGS. 2A and 2B. The app updates 150 are provided to keep the access and utilization app 140 and computerized system 100 current. The app store 160 serves as a second source for providing the access and utilization app 140 download to the computerized system 100 in contrast to downloading the access and utilization app 140 over the communications network 130 from the server system 110.

FIG. 2A illustrates block diagram of a server system 200 of a computerized system for accessing and utilizing a plurality of smartphone applications, in accordance with one embodiment of the present invention.

The server system 200 may include an output system 210, an input system 220, a memory system 230, a processor system 240, a communications interface 250, a communications system 260 and an input/output system 270. The server system 200 may include additional components and/or may not include all of the components listed above. The server system 200 is the same server system 110 illustrated and described in FIG. 1 and its description.

The output system 210 may include any one of, some of, any combination of, or all of a monitor system, a handheld display system, a printer system, a speaker system, a connection or interface system to a sound system, an interface system to peripheral devices and/or a connection and/or interface system to a computer system, intranet, and/or Internet, for example.

The input system 220 may include any one of, some of, any combination of, or all of a keyboard system, a mouse system, a track ball system, a track pad system, buttons on a handheld system, a scanner system, a microphone system, a connection to a sound system, and/or a connection and/or interface system to a computer system, intranet, and/or Internet (e.g., IrDA, USB), for example.

The memory system 230 may include, for example, any one of, some of, any combination of, or all of a long term storage system, such as a hard drive, a short term storage system, such as random access memory, a removable storage system, such as a floppy drive or a removable drive and/or flash memory. Memory system 230 may include one or more machine-readable mediums that may store a variety of different types of information. The term machine-readable medium is used to refer to any medium capable carrying information that is readable by a machine. One example of a machine-readable medium is a computer-readable medium. Memory system 230 may store one or more machine instructions for producing web pages for and collecting information for operators or establishments and/or patrons regarding wait-times at different times of the day.

The memory system 230 may also include an operating system 231, a network communications module 232, a web browser module 233, a web server application 234 and an access and utilization app 235. The operating system 231 is provided on the memory system 230. The communications module 232 enables the server system 200 to communicate on the communications network 130 and is stored on the memory system 230. The web browser module 233 allows for browsing the Internet that is stored on the memory system 230. The web server application 234 is software provided to allow for browsing on the Internet. The access and utilization app 235 is software provided to store a plurality of interactive college maps 237 and a plurality of schedule information 239 that is used by the server system 200. The access and utilization app 235 is the same access and utilization app 140 that is downloaded to the smartphone 120 described and illustrated in previous FIG. 1 and is further described in FIG. 2B and its description.

The processor system 240 may include any one of, some of, any combination of, or all of multiple parallel processors, a single processor, a system of processors having one or more central processors and/or one or more specialized processors dedicated to specific tasks. Processor system 240 may include one or more digital signal processors (DSPs) in addition to or in place of one or more central processing units (CPUs) and/or may have one or more digital signal processing programs that run on one or more CPU. Processor system 240 may implement the machine instructions stored in memory system 230.

The communication interface 250 allows the server system 200 to interface with the communications network 130 described in previous FIG. 1. Communications system 260 communicatively links output system 210, input system 220, memory system 230, processor system 240 and/or input/output system 270 to each other. Communications system 260 may include any one of, some of, any combination of, or all of electrical cables, fiber optic cables, and/or sending signals through air or water (e.g. wireless communications), or the like. Some examples of sending signals through air and/or water include systems for transmitting electromagnetic waves such as infrared and/or radio waves and/or systems for sending sound waves.

The input/output system 270 may include devices that have the dual function as input and output devices. For example, input/output system 270 may include one or more touch sensitive screens, which display an image and therefore are an output device and accept input when the screens are pressed by a finger or stylus, for example. The touch sensitive screens may be sensitive to heat and/or pressure. One or more of the input/output devices may be sensitive to a voltage or current produced by a stylus, for example. Input/output system 270 is optional and may be used in addition to or in place of output system 210 and/or input device 220.

FIG. 2B illustrates a block diagram of a plurality of smartphone applications 235 of a computerized system for accessing and utilizing a plurality of smartphone applications, in accordance with one embodiment of the present invention.

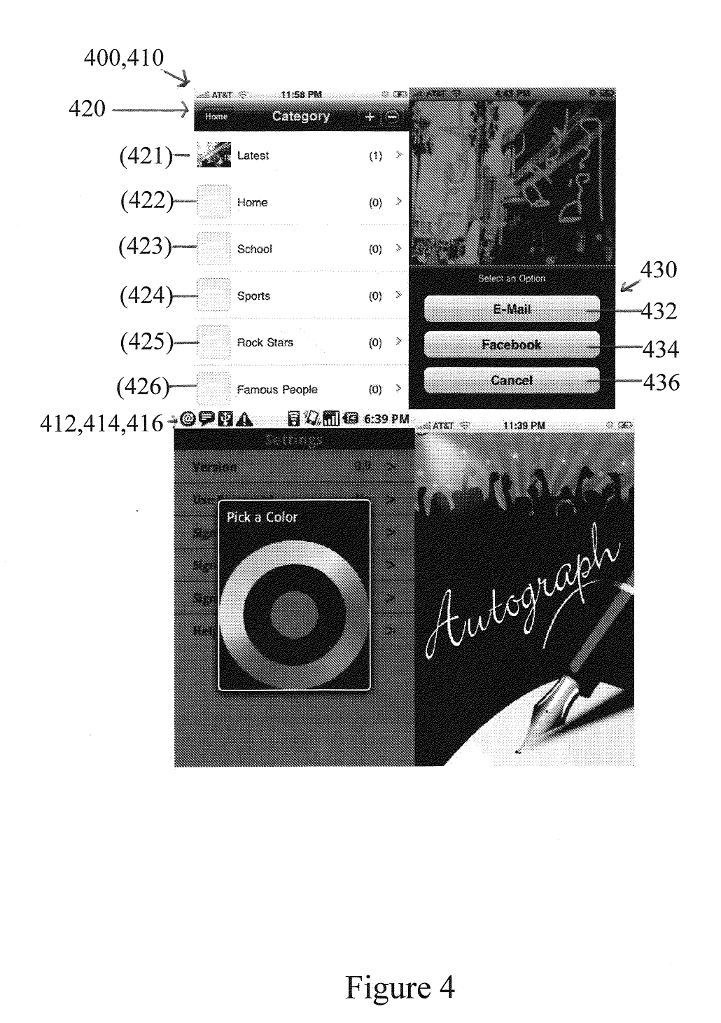

The smartphone applications 235 are the same smartphone applications described and illustrated in FIG. 2A and its description. The smartphone applications 235 include an autograph smartphone application 280, a memory puzzle smartphone application 282, a journal smartphone application 290, a coupon smartphone application 294, a restaurant takeout smartphone application 296 and a project management smartphone application 298. Further additional details regarding these smartphone applications 235 are provided in FIGS. 4 through 11C.

FIG. 3 illustrates a front perspective view of an IPhone 300 with an app for accessing and utilizing a plurality of smartphone applications, in accordance with one embodiment of the present invention.

As previously indicated in FIG. 1, the IPhone 300 can be one of the types of smartphones 120 that can receive a downloaded access and utilization app 140 and is typically the smartphone type utilized with the smartphone applications 235. The details and features of the IPhone 300 are described in U.S. Pat. No. 7,966,578 by Apple Computer.

FIG. 4 illustrates a screenshot of an autograph smartphone app 400, in accordance with one embodiment of the present invention.

The autograph smartphone app 400 includes a plurality of autograph information 410, a plurality of autograph person categories 420 and a plurality of e-mail options 430. The autograph information 410 includes a voice recording 412, a hand written signature 414 and a picture of a user's favorite personality 416. The autograph person's categories 420 include one or more of the latest autographs 421, one or more of home autographs 422, one or more school autographs 423, one or more sports autographs 424, one or more rock star autographs 425 and one or more famous person's autograph 426. The e-mail options 430 include an e-mail link 432, a Facebook link 434 and a cancel link 436. The e-mail link 432 can be utilized by a user to send their autograph information 410 to their e-mail account for storage. The Facebook link 434 can be utilized by a user to send their autograph information 410 to their Facebook account. The cancel link 436 can be utilized by a user to cancel their autograph information 410.

The autograph smartphone app allows a user to capture and indefinitely digitally store a voice recording, a hand written signature and a picture of a user's favorite personality. A user could take their phone out, open the autograph smartphone app, select a category, take a picture of the personality they get an autograph from, get the personality's autograph, record the personality's voice and save all of the information on the user's smartphone. The user can also e-mail autograph information to themselves for back-up on their PC or share it with friends and family through Facebook or other suitable social media. Children can utilize the autograph app and do any kind of free form drawings or writing for hours on the app as well as record their voice with any picture they create and add notes to the picture to remember when and where they created the picture.

The settings screen provides two options. You can select the sign color for the sketch. You can select the sign thickness for the sketch. The ‘Voice Record’ icon of the Autograph studio lets you record your voice or the celebrity's voice that is tagged with the autograph collections within a category. The ‘Camera’ icon gives a user an option to either take a new picture using the phone's camera, or browse through their photo collection. A user can also leave the screen blank. The ‘Sign or sketch’ feature allows a user to select a category where the user wants to save the autograph after obtaining the celebrity signature.

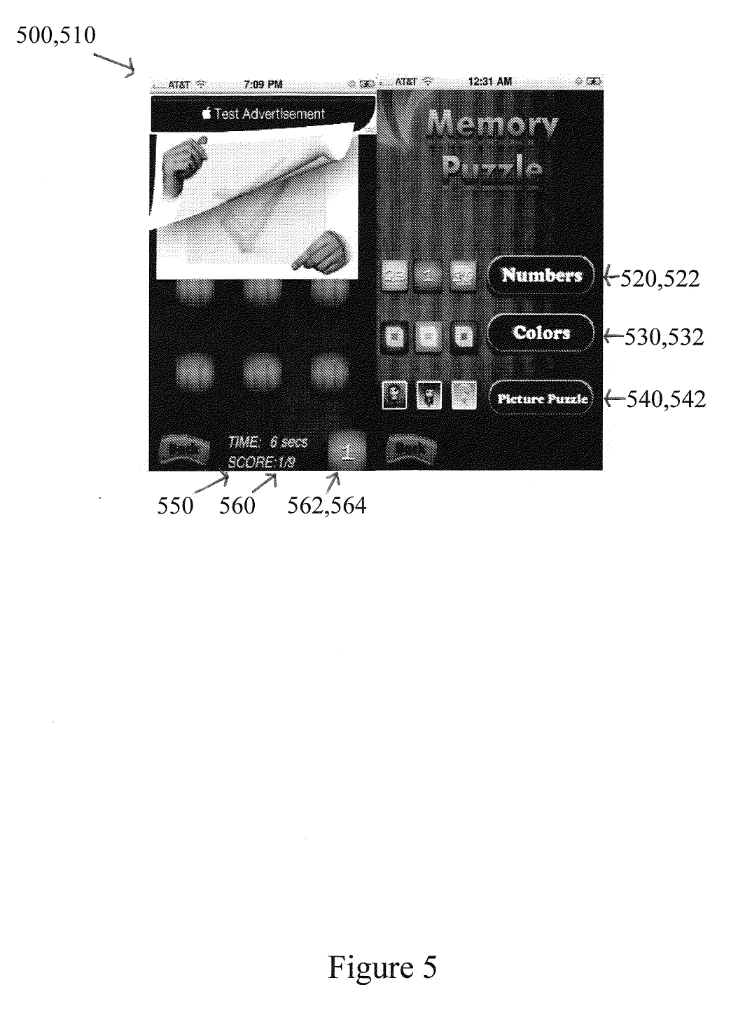

FIG. 5 illustrates a first screenshot 500 of a home page 510 of a plurality of memory puzzle of a smartphone app, in accordance with one embodiment of the present invention.

The home page 510 includes a numbers memory puzzle 520, a colors memory puzzle 530, a photo memory puzzle 540, a plurality of predetermined time periods 550 and a matrix level 560. The numbers memory puzzle 520 is designed to test a user's number sequence memory capability. The numbers memory puzzle 520 includes a sequence of numbers 522 that are memorized and recalled based on the matrix level 560 selected. The colors memory puzzle 530 is designed to test a user's color memory capability. The colors memory puzzle 530 includes a color grid 532 and a sequence of colors 534 that are memorized and recalled based on the matrix level 560 selected. The photo memory puzzle 540 is designed to test a user's photo memory capability. The photo memory puzzle 540 includes a photo sequence 542 that is memorized and recalled based on the matrix level 560 selected. The predetermined time periods 550 are chosen by a user where the user must recall the grid numbers 530 within the selected predetermined time period 550 to earn points. The predetermined time periods 550 can be any suitable predetermined time period. The matrix level 560 is selected by a user and reflects a relative difficulty and complexity of the selected memory puzzle 520,530,540. The user's score 562 is also displayed in a display window 564 disposed on the home page 510. Additionally, a user can post his scores on his Facebook page and on Twitter as well.

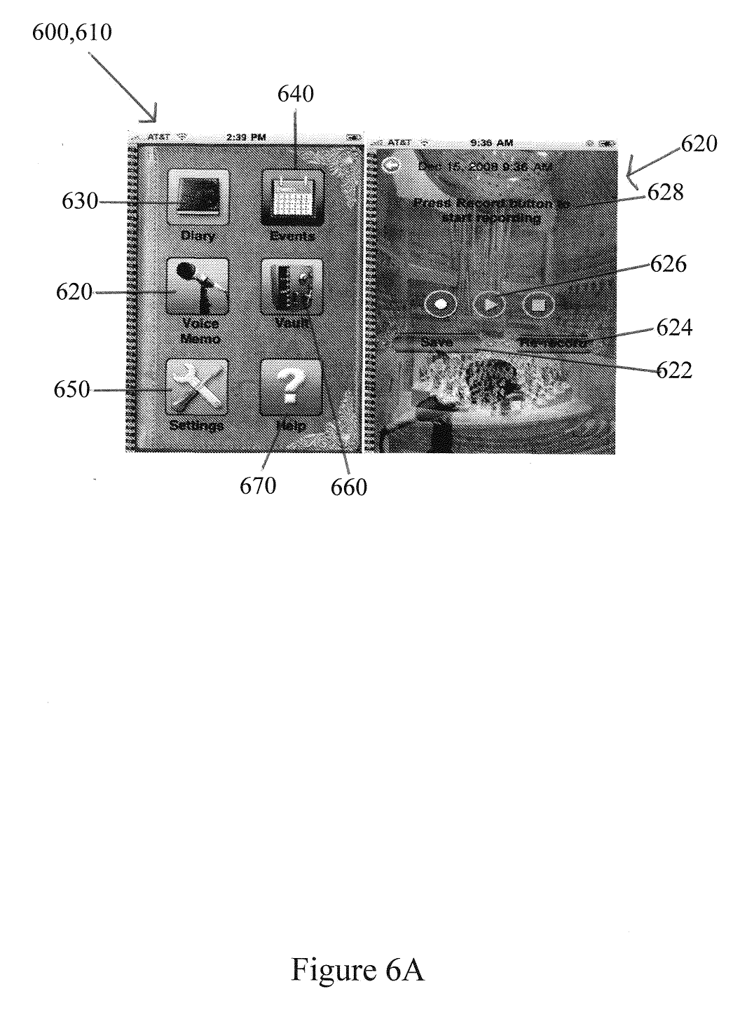

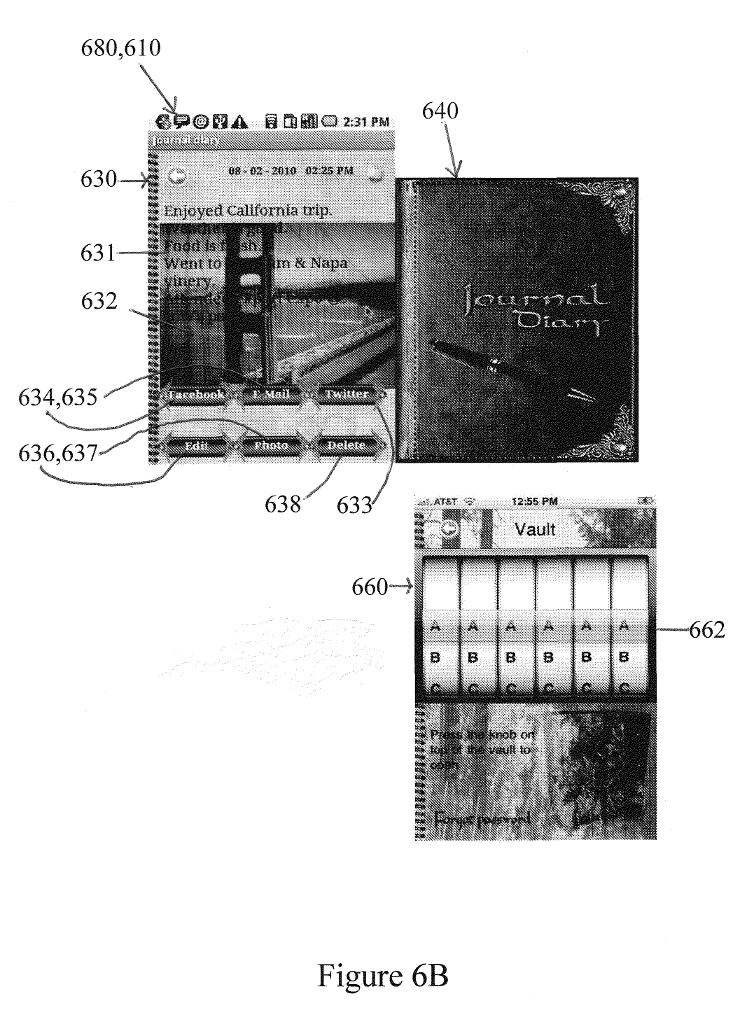

FIG. 6A illustrates a first screenshot 600 of a daily journal 610 of a smartphone app, in accordance with one embodiment of the present invention. The daily journal 610 includes a voice memo module 620, a diary module 630, an events module 640, a plurality of settings 650, a vault module 660 and a help module 670. The voice memo module 620 includes a save button 622, a record button 624, a play button 626 and a time and date stamp 628. The plurality of settings 650 includes a user's name, a selected password, a secret security question and answer and a plurality of export entries. The

FIG. 6B illustrates a second screenshot 680 of a daily journal 610 of a smartphone app, in accordance with one embodiment of the present invention. As previously described in FIG. 6A, the diary module 630 includes one or more diary entries 631, a background photo 632, a Twitter link 633, a Facebook link 634, an e-mail link 635, an edit link 636, a photo link 637 and a delete link 638. The background photo 632 can be any suitable background photo. The Tweet and Facebook links 633, 634 are typically one or more of the diary entries 631 although the user can Tweet or post any suitable entry or message on their Facebook account as well. The one or more diary entries 631 are typically posted on the background photo 632 although they may not be as well. The events module 640 allows a user to enter and save an event for any day on the calendar. The event can include the location, time, title and an added description of the event. The vault module 660 includes a password 662 and a secured memory to store any desired information such as messages, photos or other suitable information.

The daily journal lets a user record their memories, thoughts, ideas and special events with not just written words but with voice recordings, pictures, and emoticons as well. The daily journal can be customized for password protection. If a user is a physically challenged individual then the challenged individual can just type a few words and click on an emoticon and save the emoticon. A user can also Tweet or post on their Facebook account each diary entry. Also each diary entry for a given day can have its own corresponding background photo to visualize the day very easily with an added option to enter notes in landscape or portrait mode. Discreet confidential information like bank account numbers, passwords and other suitable confidential information is stored in a secured password-protected vault that resides within the application. The location (GPS) based information includes a plurality of video journals along with a timeline on a mobile device. A possibility exists to have separate web applications to interact with this app to add more features as a premium service.

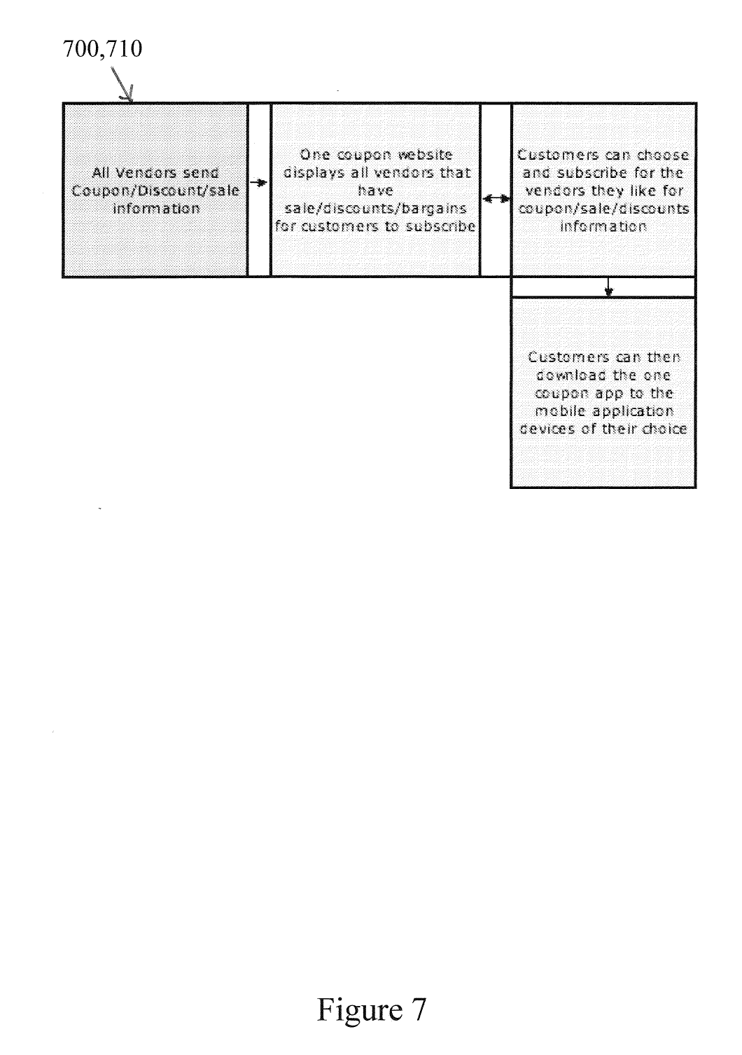

FIG. 7 illustrates a screenshot 700 of a coupon smartphone app 710, in accordance with one embodiment of the present invention.

Coupner.com is a one coupon website-portal for all other coupons available on the coupner.com website. The website utilizes a concept that is a unified way for coupons and sale-discounts management from several vendors merchants in one location that uses a single delivery method using Internet connected devices to serve its customers. This concept may be used for any product sale vendors and merchants and service providers. All vendors and merchants send their coupons, sale, discount, bargain information to the coupner.com website at regular intervals. The coupner.com website displays the vendor and merchants list that have provided the coupon, sale and discount bargains. The customer logs with his login information into the coupner.com website and subscribes to the vendor's whose coupons they prefer to see. Once they subscribe, they can see all the coupons for all the vendors and merchants they choose at one web location. The first time the customers have to register by logging on to the coupner.com website. When they provide their contact information they may choose to be notified of coupon, sale, discount and bargain expiration dates and availability of new coupon, sale, discount and bargain information for the vendors and merchants they choose. They also have the option to see the specific store information for their zip code on the website. The customer can download the coupner.com app to the mobile application device of their choice to see all the coupons, sale, discount and bargains on the Internet connected device. The coupner.com app will automatically provide location based information for the specific stores and services, coupon, sale, discount and bargains based on the internal GPS of the device. After registration customers may choose to add or modify their vendor and merchant list from the mobile application devices as well as the website.

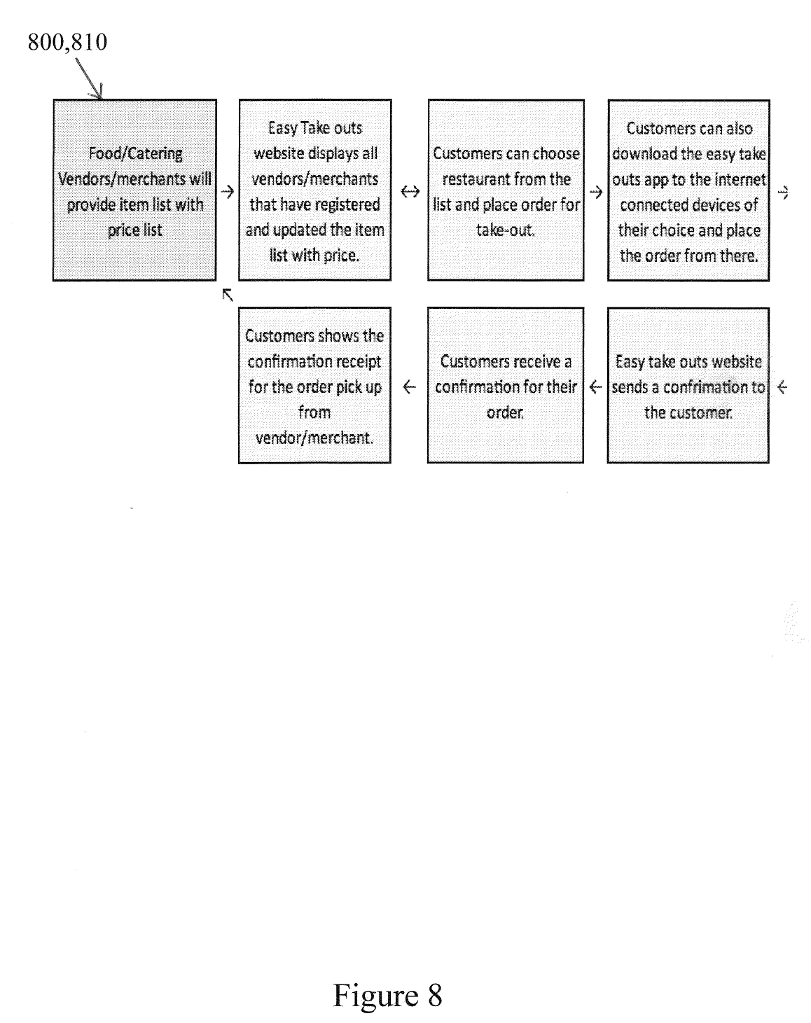

FIG. 8 illustrates a screenshot 800 of a restaurant takeout smartphone application 810, in accordance with one embodiment of the present invention.

The restaurant takeout smartphone app concept is to simplify the takeout order experience for the customers and food, catering, vendors and merchants. The restaurant takeout smartphone app supports the green earth movement by providing a way for food conservation and reducing excess waste of prepared food. Food catering vendors and merchants will register with easy take-outs and provide item lists with price at regular intervals. The easy take-outs website will display all registered vendors and merchants with their location, updated item and price list. Customers register with easy take outs and choose the restaurant from the list and place an order for take-out. The first time customers have to register by logging on to the easy take outs website. When they provide their contact information, they may choose to be notified of coupon, sale, discount and bargain expiration dates and availability of new coupon, sale, discount and bargain information for the vendors and merchants they choose from one coupon. They also have the option to see the specific vendor and merchant information for their zip code on the website. Customers can also download the easy take outs app to their Internet connected device of their choice and place an order from there. If the customer is placing the order from the Internet connected mobile device then the easy take outs app will automatically provide location based information for the specific vendors and merchants based on the internal GPS of the device. After registration customers may choose to add or modify their vendor and merchant list from the mobile application devices as well as the website. Once the customer has placed the order, easy take outs website sends an order request to the food, catering, vendor or merchant. Food, catering, vendor and merchants receive the order and sends a confirmation to easy take outs website. Easy take outs website sends a confirmation to the customer. Customer receives a confirmation for their order. Customer shows the confirmation receipt for the order pick up from the vendor and merchant.

The customer gets the ease of ordering take out from any providing vendor and merchant at any time from the tip of their hands in the least amount of time using their Internet connected device. The customer may also get moving discounts and bargains based on the vendor's preference and their frequency for takeout orders. The vendor can reduce food waste and conserve resources by planning food preparation by estimating based on the takeout orders received on a given day and looking at past history. The vendor can login to his account at easy take outs at any time to analyze customer order data including (but not limited to) most valued customer based on the frequency of order, most ordered item, least ordered item, most ordered day of the week, most ordered common celebration and holidays of the year such as Valentine's Day, Thanksgiving weekend etc. Win-win for vendor and customer-based on excessive leftovers of a certain prepared food the vendor may decide to give additional discounts for a few hours or few days at any given time and provide that information to easy take outs, easy take outs can publish that information and send a notification to its customers who have opted to receive such information. This way the customer gets an opportunity to order specific food items at a reduced cost and the vendor reduces the waste of prepared food. The earth and environment conservative food preparation based on estimation of take-out orders reduce carbon emission into the environment. Reduction in food waste extends the longevity of the resources on earth.

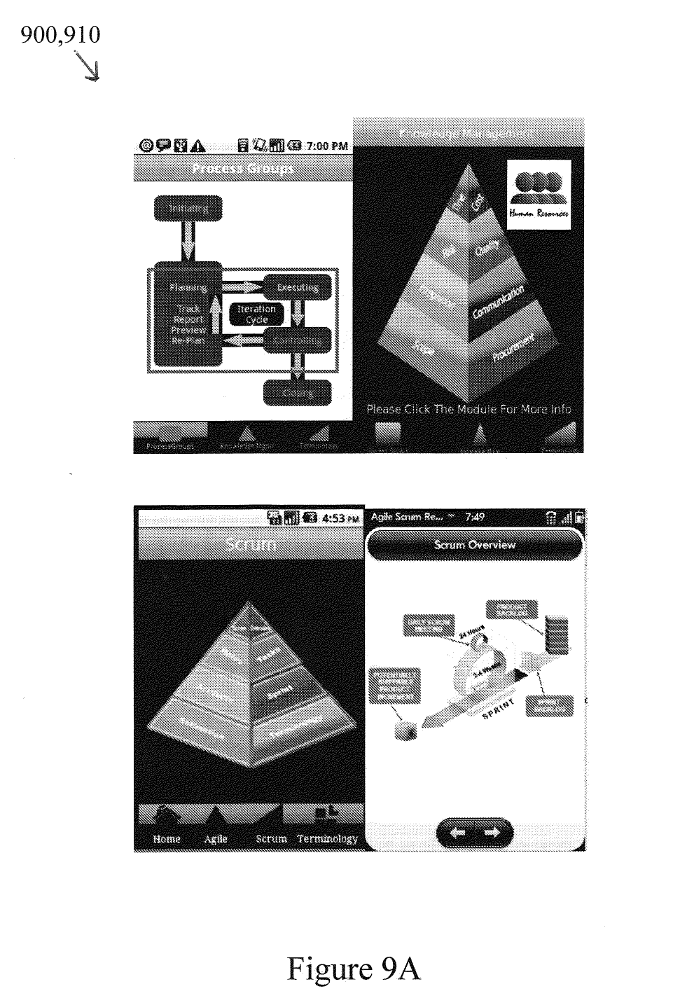

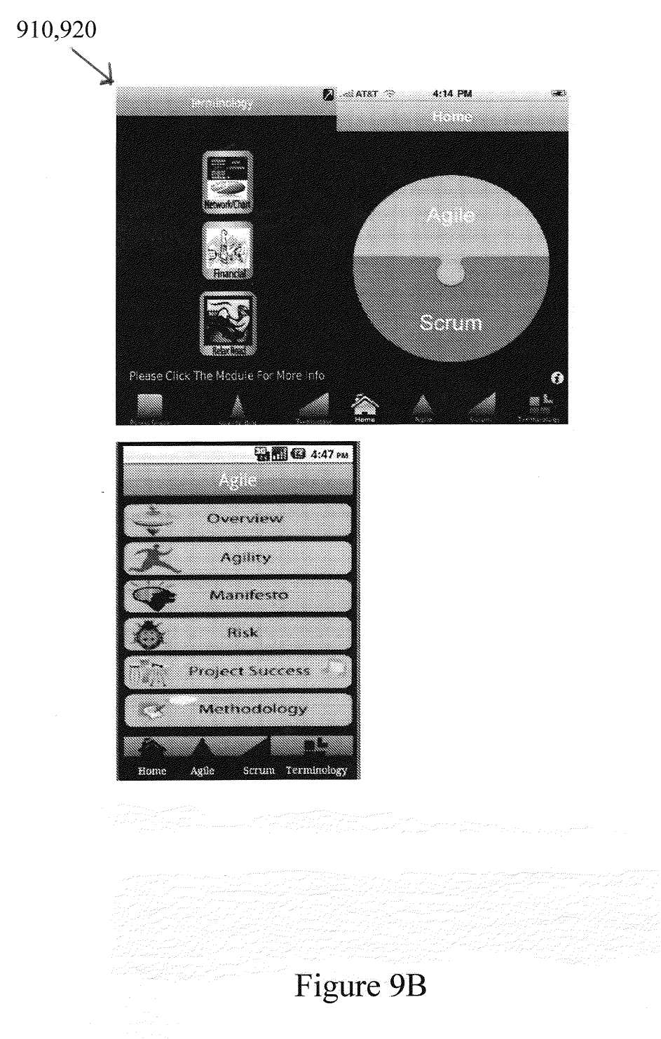

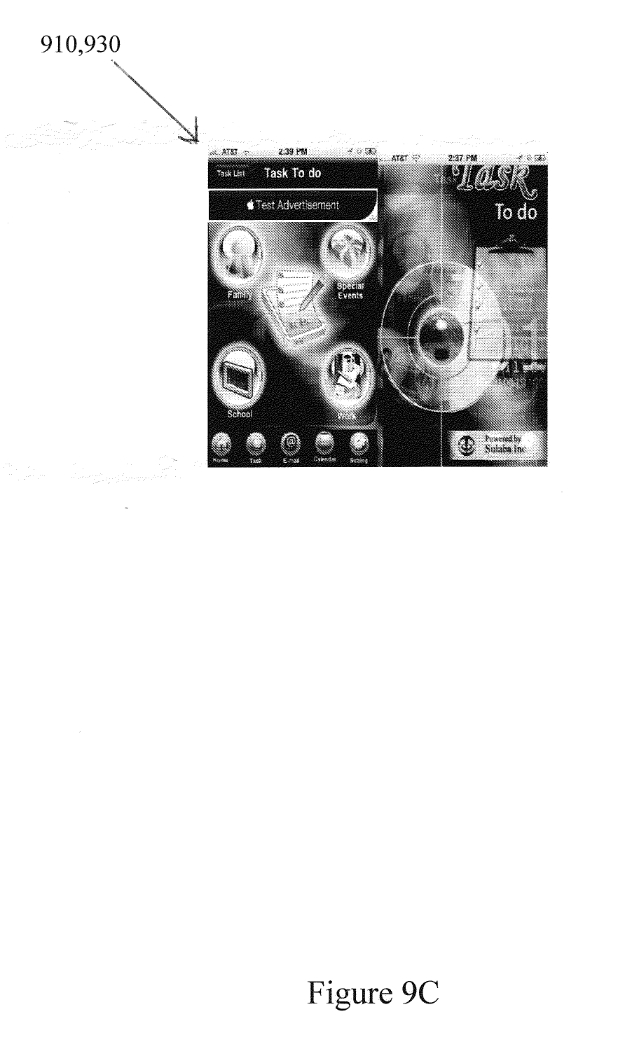

FIG. 9A illustrates a screenshot 900 of a project management smartphone app 910, in accordance with one embodiment of the present invention.

The PMP Cheat Sheet” (PMP Quick Reference) features a concise set of project management processes, formulas, terminologies and notes used for quick reference. It can be used as a memory refreshing tool by a seasoned Project management professional or as a simple, basic and brief instruction set for accomplishing a specific task by a novice project manager. The main application is divided into 3 main modules:

### 1. Process Groups

The process group's modules give a pictorial view of a project workflow, with specific tasks listed for each process. The application lists out the tasks involved for these main processes in the workflow:
Project Initiation
Planning
Execution
Controlling
Closing

### 2. Knowledge Groups

The knowledge group pyramid has specific tasks defined for various critical areas of a project management categorized as follows:
HR resource management
Time
Cost
Risk
Quality management
Communication
Integration
Scope
Procurement

### 3. Terminology

This module is a handy list of very useful formulas and terminologies mostly used by project managers in their daily duties. The main categories includes:
Network/Chart
Formulas/Terminology
Relax reading/Miscellaneous

FIG. 9B illustrates a screenshot 920 of a project management smartphone app 910, in accordance with one embodiment of the present invention.

### Application Features

High Level Project Management workflow
Project Management calculations and formulas
PM Terminologies
Time management basics
Cost management basics
Scope management basics
Risk management basics
Resource management basics
Network and Chart basics

The “Agile Serum Cheat Sheet” application (Agile Serum Quick Reference) features a concise set of agile project management process flow, serum methodology, formulas and glossary for quick reference. It can be used as a memory refreshing tool by a seasoned project management professional or as a simple, basic and brief instruction set for accomplishing a specific task by a novice project manager. The main application is divided into 3 main modules:

FIG. 9C illustrates a screenshot 930 of a project management smartphone app 910, in accordance with one embodiment of the present invention.

### 1. Agility

The agility module gives high-level overview of following:
Agile Overview
Agility
Manifesto
Risk
Project Success
Methodology

### 2. Serum

The Serum module gives high-level overview of following:
Serum Overview
Risks
Tasks
Artifacts
Sprint
Estimation
Terminology

### 3. Glossary

This module is a handy list of very useful formulas, terminologies mostly used by agile project managers in their daily duties using serum methodology.

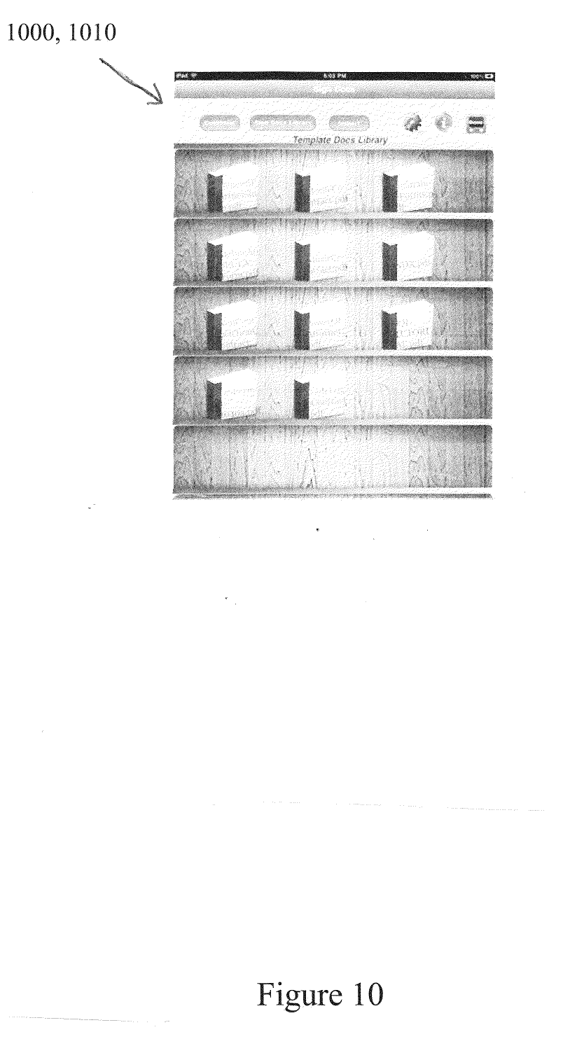

FIG. 10 illustrates a screenshot 1000 of a signed doc app 1010, in accordance with one embodiment of the present invention.

Whether a user is a mortgage broker, leasing agent or notary public, say goodbye to time consuming paper transactions. Whatever business a user is in, that user should look into the present and ride the wave of the future. The sign doe app focuses on what matters most to a user. Go green, organize a business and get piece of mind with unprecedented flexibility in managing document. Manage documents by client and project, and store as many files per client as needed. Create labels within seconds and drag them to the appropriate fields within the document to have them filled out prior to meeting a client. Made a mistake? Correct it immediately without messy white outs by editing or deleting the label. Is a client too busy to meet in person? Send the file by email and let them return it to you with their signature and date. Forgot to double check whether a client signed all of the necessary documents? Is it too late to go back to the office to check? Forget the hassle and pull the files up on your screen!

The signed doc app includes no additional costs after the app is purchased, has an easy to follow demo tutorial within the app, has an easy to import an email PDF attachments straight into the sign docs app and export the signed document as an email, access to a private network through FTP or Desktop iTunes to import or export documents through Email or FTP, organizes the customer, project-based template pdf doc library as well as signed library in a rich user interface book shelf, no limit on template docs, signed docs or customer projects, has no limit on custom labels, color text, pen or size, no limit on number of signatures and timestamps, has an easy drag and drop of labels within each page of document, has a custom digital pen size color, label text font, etc has an extensive real life look and feel book shelf library of projects (Template or Signed), can lock and unlock a document while signing, can save signed documents with different file names under as many project folders as needed, can import and export documents through a user's own or company FTP site (subject to user access restrictions), has intuitive customer/project image cover flow screen, can touch and drag customer images to see the projects, can print the signed documents immediately with apple iPad supported air p1int/WiFi connected printer devices, can customize for personal, small business, retail and enterprise level, can support the ‘go green’ wave, eliminate paper waste, preserve our earth and increase productivity and requires iPad OS 4.0+.

Other apps include a race gear app which is a revolutionary 3D car racing and learning tool for both kids and teenagers. Breaking too hard? You will see marks on the road. Try not slowing down enough before a wide turn and your car will slide, hit a divider or even spin out of control. Learn the physics of driving by practicing u-turns, sharp turns, wide turns, blind turns and find the optimal speed for each. With intuitive steering and breaking, you will be in control before you know it. Put your car in reverse and see what improper handling can do to your car within seconds. Drive safe so that you can be a real racer in real life. Let's dedicate us to safe driving and make our roads a better place for everyone.

Camera button—dynamically to change the inside and outside of the car views while driving.

Choose the car color (Red, Black, Blue, Yellow, Pink, etc.)

Various controls offered for accelerometer and steering controls

Steering:

Rotate the steering wheel to maneuver the car.

### Paddles:

Press Bottom left paddle to apply breaks.

Press Middle paddle to apply reverse throttle.

Press Bottom right paddle to accelerate.

### Sticks:

Vertical stick:

Slide the vertical stick to accelerate or slide it down towards red to apply reverse throttle.

Horizontal stick:

Slide the horizontal stick left or right to steer.

### Motion: (Using Accelerometer)

Holding the device in landscape mode. Rotate it back-and-forth to accelerate and rotate left/right to steer.

Various play modes:

### Timer Mode:

Complete the lap in less than the Best time to win,

### Countdown Mode:

Complete the lap before the countdown over.

Drifting Mode

Speed up the car

Turn steering wheel to left or right abruptly

When the steering wheel is turned cornpletely left or right, press and hold the break button.

### Sound Controls:

On/Off: Toggle the sounds on or off,

Music: Adjust the slider to set the music volume.

Sfx: Adjust the slider to set the Sfx volume

Beautiful scenic mountain terrains view all along, curved divided road tracks, bridges, tunnel partial gorgeous scenic view from tunnel signs, etc.

Night Mode is available on Mac X & PC platform with higher resolution of Graphics.

Please note certain options and features will depend on the platform, device & OS.

Another app is Word-Teaser, which is a fun and compelling game for all ages. More than just entertainment, it's designed to improve visual acuity and pattern recognition skills critical for speed reading and scanning, which will turn are essential for academic success, Feel your brain in high gear! Word-Teaser tests your skills against timed challenges. Each challenge requires you to find words hidden in

an animated background. The words can be displayed in their regular form, or with letters reversed, jumbled, truncated, or replaced with. For each challenge, you can choose the number of words and set the difficulty level Word-Teaser is designed to extend your visual and cognitive processing speed in gradual, easy steps. Word-Teaser's most exciting feature lets you create your own custom word-lists and play challenges based on your favorite topics—for example, animals, flowers, or science—or any other topics you can imagine. Word teaser is great for students who want to learn words in a specific subject. There's also a leader-board that you can share on Face book, to add a competitive dimension to the fun and keep things interesting. Players hone their vocabulary and spelling skills, while learning to focus and concentrate for long periods, making Word-Teaser popular among parents. Word-Teaser comes in three flavors—Lite (free), Regular, and Pro. Although many great features are available in all versions, custom word-lists and multiple-user functionality are offered only in Regular and Pro versions. Three other advanced features are offered only in the Pro version: ASCII letter-replacement, timer and leader-board sharing.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A system to access and utilize a plurality of smartphone applications, comprising:
a server system;
one or more smartphones;
a communications network where said server system is in communication with said smartphones over said communications network downloads;
an autograph smartphone application that includes a plurality of autograph information, a plurality of autograph person categories and a plurality of e-mail options; and
a plurality of app updates that are provided to said college navigator app and to keep said system current.

2. The system according to claim 1, wherein said smartphones are a client system.

3. The system according to claim 1, wherein said smartphone is selected from the group consisting of an IPhone, a Blackberry or a Droid.

4. The system according to claim 1, wherein said communications network is selected from the group consisting of one or more local area networks, wide area networks, wireless networks, telephone networks and the Internet.

5. The system according to claim 1, wherein said autograph information includes a voice recording, a hand written signature of said autograph person and a picture of said favorite personality.

6. The system according to claim 1, wherein said autograph person's categories include one or more of latest autographs, one or more of home autographs, one or more school autographs, one or more sports autographs, one or more rock star autographs and one or more famous person's autographs.

7. The system according to claim 1, wherein said e-mail options include an e-mail link, a Facebook link and a cancel link.

8. A system to access and utilize a plurality of smartphone applications, comprising:
a server system;
one or more smartphones;
a communications network where said server system is in communication with said smartphones over said communications network downloads;
a memory puzzle smartphone application that includes a numbers memory puzzle, a colors memory puzzle and a photo memory puzzle; and
a plurality of app updates that are provided to said college navigator app and to keep said system current.

9. The system according to claim 8, wherein said smartphones are a client system.

10. The system according to claim 8, wherein said smartphone is selected from the group consisting of an IPhone, a Blackberry or a Droid.

11. The system according to claim 8, wherein said communications network is selected from the group consisting of one or more local area networks, wide area networks, wireless networks, telephone networks and the Internet.

12. The system according to claim 8, wherein said numbers memory puzzle includes a sequence of numbers that a user memorizes and recalls based on a first difficulty matrix level and a first plurality of predetermined time periods.

13. The system according to claim 8, wherein said colors memory puzzle includes a color grid and a sequence of colors that are memorized and recalled based on a second matrix level and a second plurality of predetermined time periods.

14. The system according to claim 8, wherein said photo memory puzzle includes a photo sequence that is memorized and recalled based on a third matrix level and a third plurality of predetermined time periods.

15. A system to access and utilize a plurality of smartphone applications, comprising:
a server system;
one or more smartphones;
a communications network where said server system is in communication with said smartphones over said communications network downloads;
a daily journal application that includes a voice memo module, a diary module, an events module, a plurality of settings, a vault module and a help module; and
a plurality of app updates that are provided to said college navigator app and to keep said system current.

16. The system according to claim 15, wherein said smartphones are a client system.

17. The system according to claim 15, wherein said smartphone is selected from the group consisting of an IPhone, a Blackberry or a Droid.

18. The system according to claim 15, wherein said communications network is selected from the group consisting of one or more local area networks, wide area networks, wireless networks, telephone networks and the Internet.

19. The system according to claim 15, wherein said diary module includes one or more diary entries, a background photo, a Twitter link, a Facebook link, an e-mail link, an edit link, a photo link and a delete link.

20. The system according to claim 15, wherein said events module includes an event location, an event time, an event title and an added description of said event.
